(19) United States
(12) Patent Application Publication
(10) Pub. No.: US 2006/0018642 A1
(43) Pub. Date: Jan. 26, 2006

(54) Mobile laser designated infrared multimedia mapping system

(76) Inventor: David V. Chaplin, Oroville, CA (US)

Correspondence Address: DAVID CHAPLIN, 2810 HIGHWAY 32, CHICO, CA, 95973, US

(21) Appl. No.: 10/894,022

(22) Filed: Jul. 20, 2004

(51) Int. Cl. G03B 39/00

(52) U.S. Cl. 396/7

(57) ABSTRACT

A system for collecting GPS positioning data in correlation with infrared imagery and digital imagery from an aerial based platform. The system can complete the said data collection assignments without requiring physically connecting any hardware or sensors to the exterior of the aircraft. Our inventions exclusive niche in the aerial remote sensing industry consists of a mobile hardware platform, which facilitates mounting an array of cameras, sensors, and recording equipment inside the aircraft without any hardware mounted to the exterior of the aircraft. The mobile hardware platform supports multiple types and configurations of cameras and a diverse sensor array. The preferred embodiment of the sensory and camera configuration operates concurrently in real-time to facilitate the data collection process. The said preferred embodiment allows an operator to collect infrared imagery, digital imagery, and geopspatial position coordinates for a single target or multiple targets simultaneously. The system was also designed to enable the data collection process during normal flight without requiring the aircraft to hover or reverse direction. Due to the field of view and mobility the tree-way tripod head provides, targets can be acquired and recorded while the aircraft is in motion. The MOBILE LASER DESIGNATED INFRARED MULTIMEDIA MAPPING SYSTEM was designed for, but not limited to, use on forest fire monitoring, utilities inspections, and riparian wildlife and habitat mapping homeland security, agricultural inspection, forest management, burn area rehabilitation assessment, HAZMAT assessment, surveillance, aerial perimeter mapping and calculations, and many other remote sensing applications.

### BACKGROUND

1. Field of the Invention

This invention relates generally to aerial based data acquisition, specifically to a system employing an internally mounted mobile hardware platform, which supports an array of cameras and sensors to simultaneously collect data from an aerial platform.

2. Prior Art

The use of cameras and sensors in aerial based data acquisition has been widely used throughout the latter half of the 20^{th} century. Particularly infrared remote sensing has been also widely used throughout the said timeframe as well for forest fire management, utilities inspections, agricultural surveys, weather, surveillance, and for geological survey. This patent illustrates a mobile hardware platform, which is used to host an array of cameras and sensors to collect the said information from inside an aircraft. The mobile hardware platform was designed to specifically host multiple types of cameras and multiple types of positioning and internal navigation sensors. The said hardware configuration and preferred embodiment allows us to collect data from the interior of most rotorcraft or fixed wing aircraft. All previous similar camera and sensor combinations systems have been traditionally fixed or mounted to the exterior of the aircraft as exemplified in U.S. Pat. App. No. 0020081110, issued to Johnson. Our mobile hardware platform design enables our system to collect the same type of data from inside the aircraft. This type of data collection is similar to the traditional Forward Looking Infrared System's gimble ball mounting assembly, which collects the same type of data from the exterior of the aircraft.

Our system collects infrared and digital video imaging simultaneously, similar to U.S. Pat. No. 5,045,93 issued to Myrick. The primary difference between Myrick's system and our invention is that our invention also records correlating digital and infrared imagery for each individual target but our invention also correlates the imagery to GPS derived geo-referenced positional coordinates. There have also been various other systems that utilize Global Positioning Systems antennas and receivers to facilitate GPS data collection and area mapping such as U.S. Pat. No. 6,198,431 to Gibson, which uses the said GPS information to create customized topographical maps from a ground based data collection system. Our system also uses GPS frequencies and time codes to correlate and coordinate positional information but we collect this information specifically from an aerial platform. Not only do we use a GPS signal to collect positioning information in reference to ground based targets, we also utilize a laser rangefinder which works in conjunction with a magnetic fluxgate compass and integrated tilt sensor to acquire targets anywhere with in our systems Field of view separately from the GPS source data streaming in real-time.

Another system, which shares many technological similarities with our system, U.S. Pat. No. 5,386,117 to Piety, which utilizes an infrared camera in correlation with a digital camera to detect geothermal disturbances specifically for underground or ground based applications. Piety's mobile hardware mount is similar to a dolly, where the user would actually roll the equipment around the test site. Our infrared camera and digital camera are mounted to the mobile hardware platform made specifically for aerial based data collection. U.S. Pat. No. 4,910,593, to Weil, also utilizes the infrared and digital cameras for geological defect detection but this invention does not incorporate GPS positioning information or the ability to range targets from a distance.

U.S. Pat. No. 5,818,951, awarded to Schively, utilizes an aerial based platform for equipment, which collects infrared and digital correlating images specifically for roof inspection. Their system does not tie in Global Positioning Systems positioning coordinates or any type of GPS based mapping to their process. While our system collects similar imaging data simultaneously from an aerial based data collection platform, our imaging data is collected in conjunction with geo-spatial positional data. This additional feature enables our computer to generate aerial topographical maps with correlating infrared and digital photos for any desired target acquired during or after aerial based data collection.

Another patent similar to ours, U.S. Pat. No. 5,592,151 to Rolih, employs infrared cameras to detect hotspots on fires and also acquires GPS positioning information for the said thermal hotspots as well. This system, while very similar to ours in information collection and output has one major difference, it is mounted exclusively to the exterior of the aircraft. Our mobile hardware platform has nothing which physically attaches to the exterior of the aircraft. Our invention is the first system, which facilitates the mounting of cameras and sensors inside an aircraft for aerial based data collection outside the aircraft, and it has absolutely nothing connected to the exterior of the aircraft.

U.S. Pat. No. 5,999,211 to Hedges, does have many similarities to our system. Hedges airborne camera system and methodology utilizes a mobile camera system and GPS data acquisition hardware to collect data from an aerial based platform. Once again this systems major difference from ours is that it is physically attached to the exterior of the aircraft.

A more recent patent application published Dec. 25, 2003, U.S. Patent Application No. 20030234862 by Anderson, employs an aircraft mounted video recording system. This system is also fixed to the exterior if the aircraft, and again it is nothing close to the type of hardware mounting configuration we have developed. Our mobile platform can support similar sensory, imaging, and data recording equipment from inside the aircraft.

While our system can be used for fire perimeter mapping it also has many other ramifications. U.S. Pat. No. 5,160,842 awarded to Johnson, an invention, which is used primarily for aerial based data collection and creating a thermographic based perimeter organized onto topographical maps for presentation and analysis. While our system can also be utilized for the same functionality we are not limited to fire perimeter mapping. Using our laser designated targeting system we can add any type of feature to a perimeter-based map including water sources, helipads, dozer lines, or any other feature, which requires GPS positioning coordinates. The said laser designated targeting capabilities can acquire and record positional information simultaneously while the perimeter is being recorded. Our system can also be used for several other applications and is not limited to fire mapping. We can use our system for utilities inspection, electrical inspection, homeland security, wildlife mapping, commercial building insulation inspections, search & rescue, marijuana eradication, surveillance, riparian habitat mapping, and many types of other aerial based data collection.

Of all the prior art searched I found one characteristic of our system that could not be found in any other patent or prior art, our mobile hardware platform 10. The use of this unique platform is what enables us to mount and coordinate multiple camera and sensor arrays from the interior of an aircraft. Every other aerial based remote sensing system was mounted to the exterior of the aircraft. Our system is the only one in the world which can collect GPS data, acquire ranged targets independent of the source GPS real-time, create GPS perimeters, locate hotspots via infrared thermography, capture correlating infrared and digital still photos for each desired target along with the said target's correlating GPS position from the interior of the aircraft. Every other similar system or prior art we searched required the cameras and sensors be hard mounted to the exterior of the aircraft.

### OBJECTS AND ADVANTAGES

After reviewing all prior art I have found several objects and advantages of our invention. It's ability to collect many types of imagery and positioning data from an aerial platform based specifically inside an aircraft is what truly separates it from the competition. Due to its portability, and the fact that there is nothing that attaches physically to the exterior of the aircraft, it can be operated in almost any rotorcraft or light, fixed-wing aircraft from a low or high altitude. The operator directly controls all the cameras and sensors, which are mounted next to the operator on the three-way tripod head, from within the aircraft. The operator's body weight actually serves as a mounting tool by adding weight to the base of the mobile hardware platform 102. Because the preferred embodiment of the mobile hardware platform 10 fits around the operator, it currently requires a human operator as part of its physical mounting requirements. All other aerial based mapping and infrared camera systems we've investigated require a considerable amount of exterior hard mounting and assembly prior to take-off due to their external mounting requirements. Once an operator is seated inside the mobile hardware platform 10, the operator complete MOBILE LASER DESIGNATED INFRARED MULTIMEDIA MAPPING SYSTEM is ready for take-off. Our mobile system can be placed completely inside an aircraft during ferrying as well. Our system requires little or no prior set-up time, which also makes our system easier to prepare for flight than any other similar system today. Because the FAA has stringent regulations on hardware attached to the exterior of the aircraft, our system remains exempt from these laws due to the fact it functions from inside the aircraft with nothing mounted to the airframe. Therefore our system is physically easier and faster to integrate into almost any rotorcraft or fixed wing aircraft, so long as they can operate with one door or window open. The only drawback to our system stems from its core competency. Our system more vulnerable to weather than it's externally mounted competitors due to its current design. Because the traditional enclosed gimble ball mounted system is completely enclosed it can operate safely in rain or other adverse conditions while our camera system cannot be exposed to rain or prolonged moisture for long periods of time. However we are currently designing a composite casing to house our cameras and sensors, which would provide much more durability against the weather and elements. Our system can also be broken down into smaller components for easier travel. The mobile hardware platform 10 can be disassembled relatively quickly and can then be placed in its custom case for air travel. Further objects and advantages to our invention will become apparent from a consideration of the drawings and ensuing description of it.

### DESCRIPTION OF DRAWINGS

These and other features of my invention will become more apparent from the following description in which reference is made to the appended drawings, the drawings are for the purpose of illustration only and are not intended to in any way limit the scope of the invention to the particular embodiment or embodiments shown, wherein:

FIG. 1A is an overhead perspective of the back of the mobile hardware platform. This drawing shows a transparent mobile hardware platform without any sensors or cameras.

FIG. 1B is also an overhead perspective from a different angle. This angle shows the front of the mobile hardware platform.

FIG. 1C is a side angle of the mobile hardware platform. This angle shows one version of the means of adjustment for different sized operators.

FIG. 1D is a top view of the mobile hardware platform.

FIG. 1E is a view from the front of the mobile hardware platform.

FIG. 2A is a schematic of the preferred method of hardware configuration for the MOBILE LASER DESIGNATED INFRARED MULTIMEDIA MAPPING SYSTEM, prior to mounting to the mobile hardware platform 10. This schematic shows only one of many possible ways to configure cameras, sensors, data acquisition hardware, and a mobile computer to facilitate simultaneous GPS positional data collection along with correlating infrared and digital imagery.

FIG. 2B is a view of the mobile hardware platform with the preferred embodiment of the camera and sensor assembly. This includes, but is not limited to, the standard camera, sensory, and hardware configuration for most general applications. The said hardware arrangement is the preferred embodiment by the inventor for the average assignment. Although the said configuration is the preferred embodiment of the invention, the camera and sensory configuration can be changed or modified at any time according to the desire output.

FIG. 3A is a view of the MOBILE LASER DESIGNATED INFRARED MULTIMEDIA MAPPING SYSTEM in a standard position ready for data collection from within a helicopter. This drawing is used to primarily illustrate the operator's position in respect to the aircraft and the MOBILE LASER DESIGNATED INFRARED MULTIMEDIA MAPPING SYSTEM.

FIG. 3B is a view of the operator and MOBILE LASER DESIGNATED INFRARED MULTIMEDIA MAPPING SYSTEM in flight. The field of view refers specifically to the three-way tripod head's mobility limitations.

FIG. 3C is a view from behind the helicopter. This specifically shows the radius of vertical motion and the current limitations of the three-way tripod head in the mobile hardware platform.

FIG. 3D shows a view from above the helicopter. This view shows the limited radius of movement for the three way tripod head, which houses the cameras and sensors.

### REFERENCE NUMERALS IN DRAWINGS

10 The complete mobile hardware platform
20 Multi-directional three-way tripod head with complete camera and sensor assembly
101 Top pieces of mobile hardware platform, operator's working area
102 Bottom portion of mobile hardware platform, adjustable to different operators
103 Tripod head mounting arm
140 Three-way tripod head
105 Customized camera and sensor mounting plate
106 Data recorder elevated base
107 Means for adjustment of mobile hardware platform
200 Infrared or multi-spectral camera
201 Visual imaging camera
202 Magnetic digital fluxgate compass with integrated tilt and roll sensors
203 Laser rangefinder
204 GPS antenna or geo-spatial data acquisition antenna
205 Mobile computer
206 Power inverter to convert DC power to AC power
207 Data recorder
208 Data acquisition hardware for laser rangefinder
209 Modified plug to fit aircraft's power extensions
210 Data acquisition hardware for the magnetic fluxgate compass with tilt sensors
211 Data acquisition hardware for the GPS antenna 204, consists of GPS receiver and cabling or other geo-spatial data acquisition apparatus
301 The helicopter or aircraft
302 The operator, or human interface

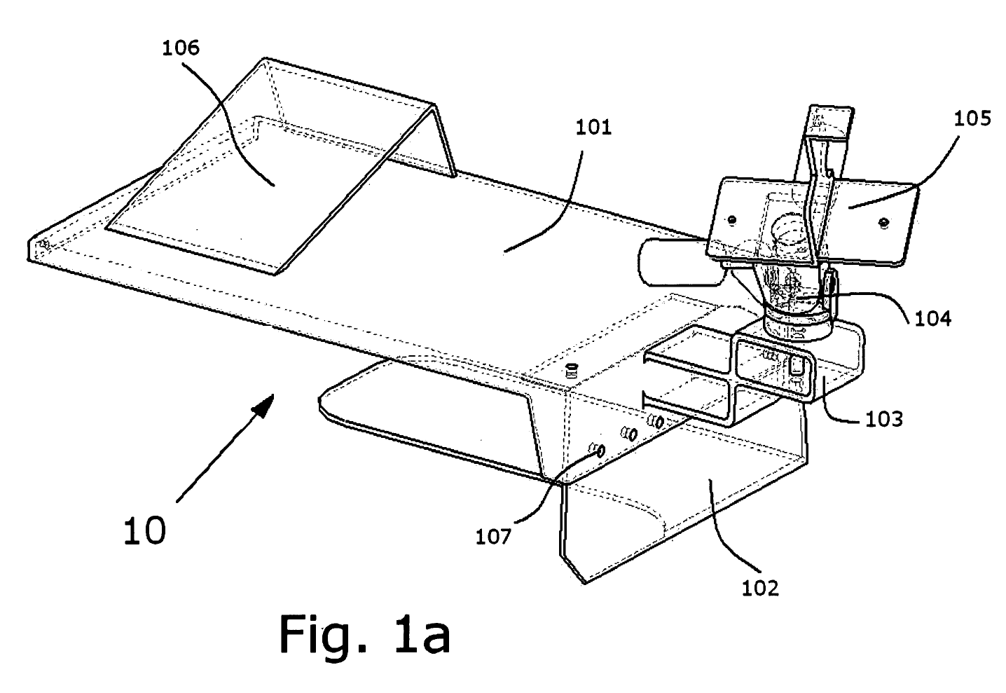

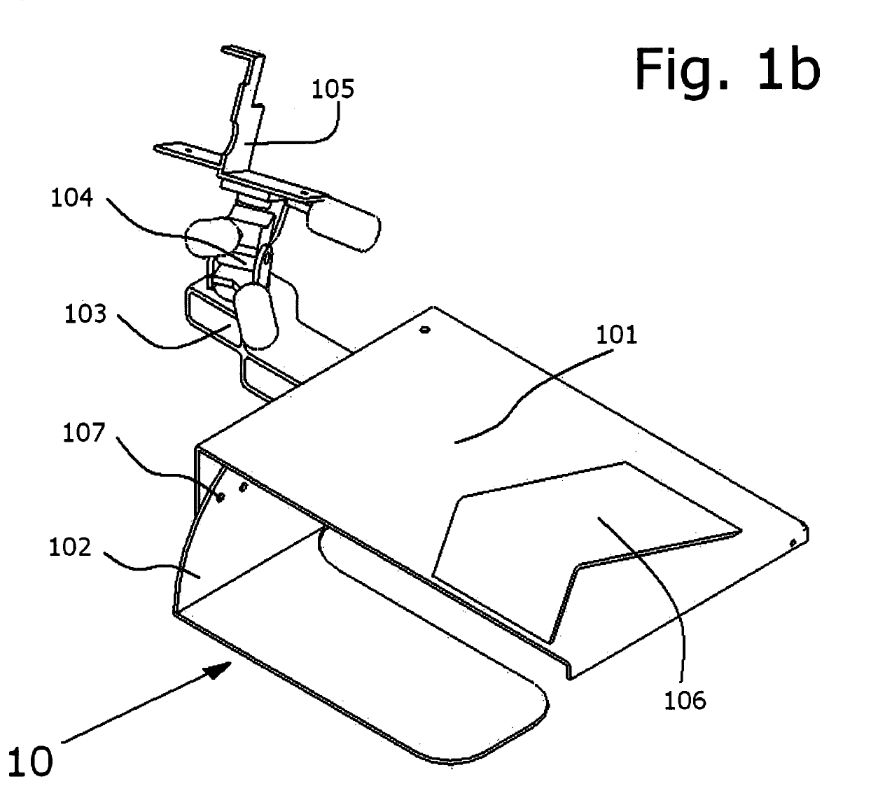

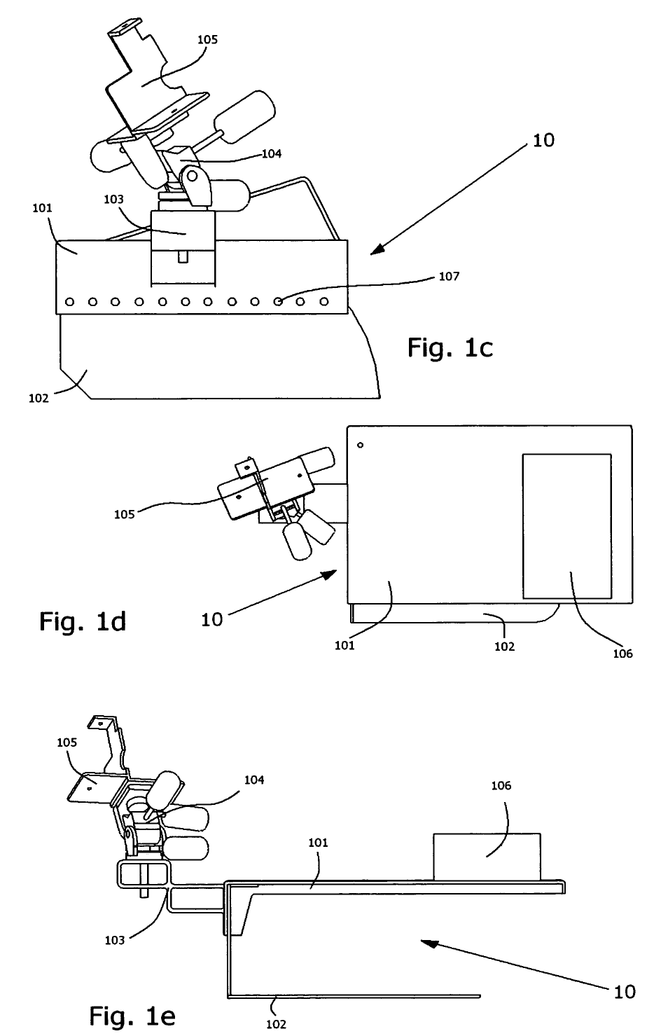

### DESCRIPTION—FIGS. 1a TO 1e (STATIC DESCRIPTION OF FIGURES)

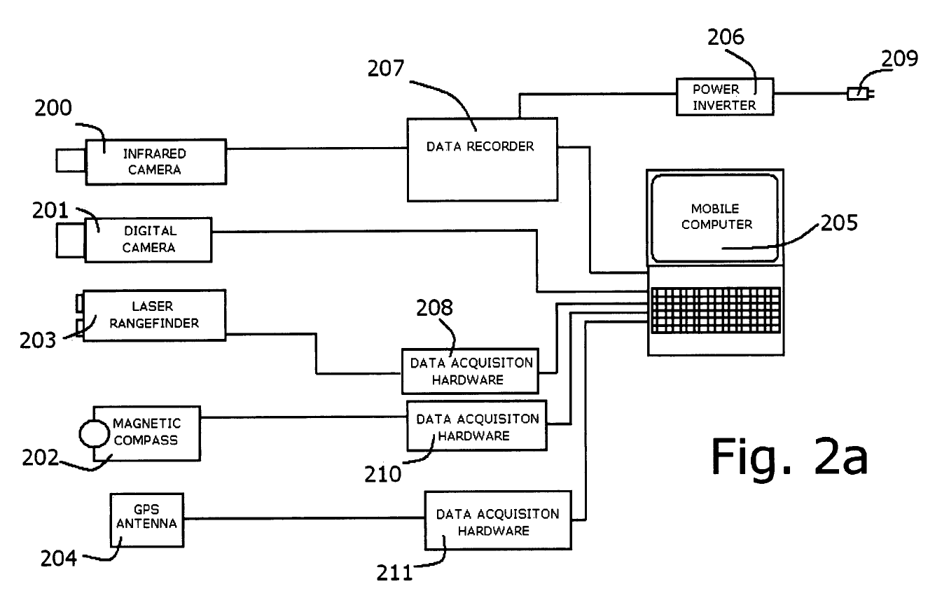

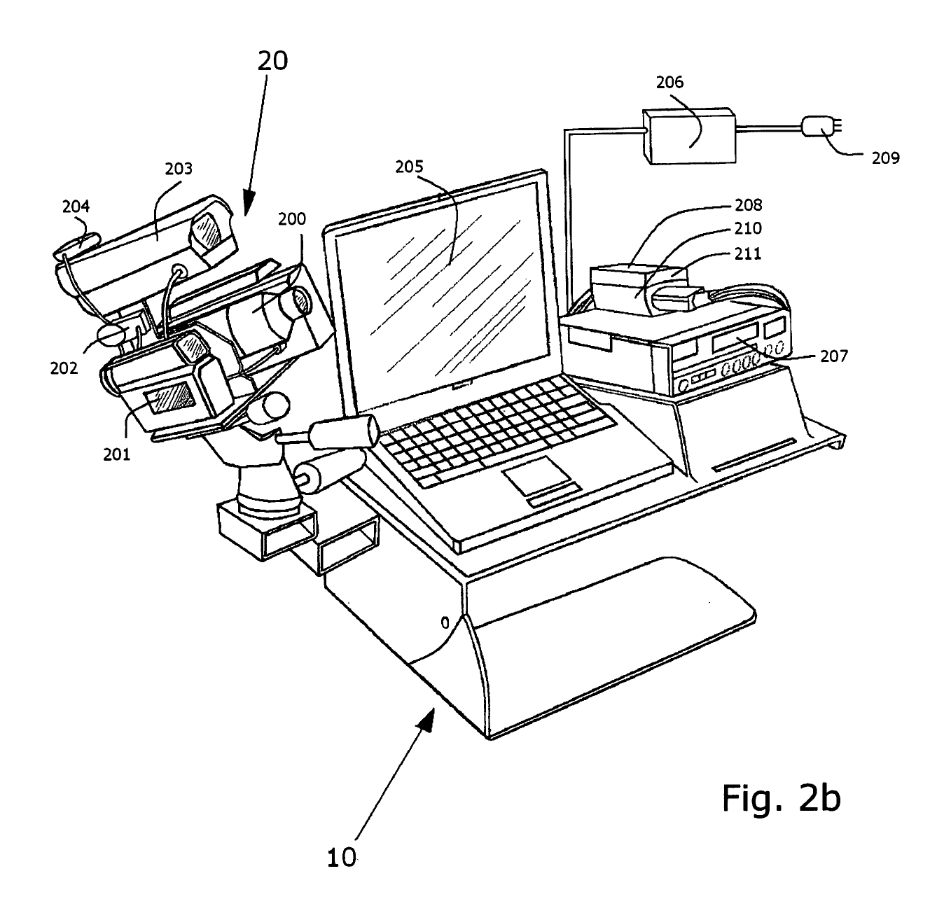

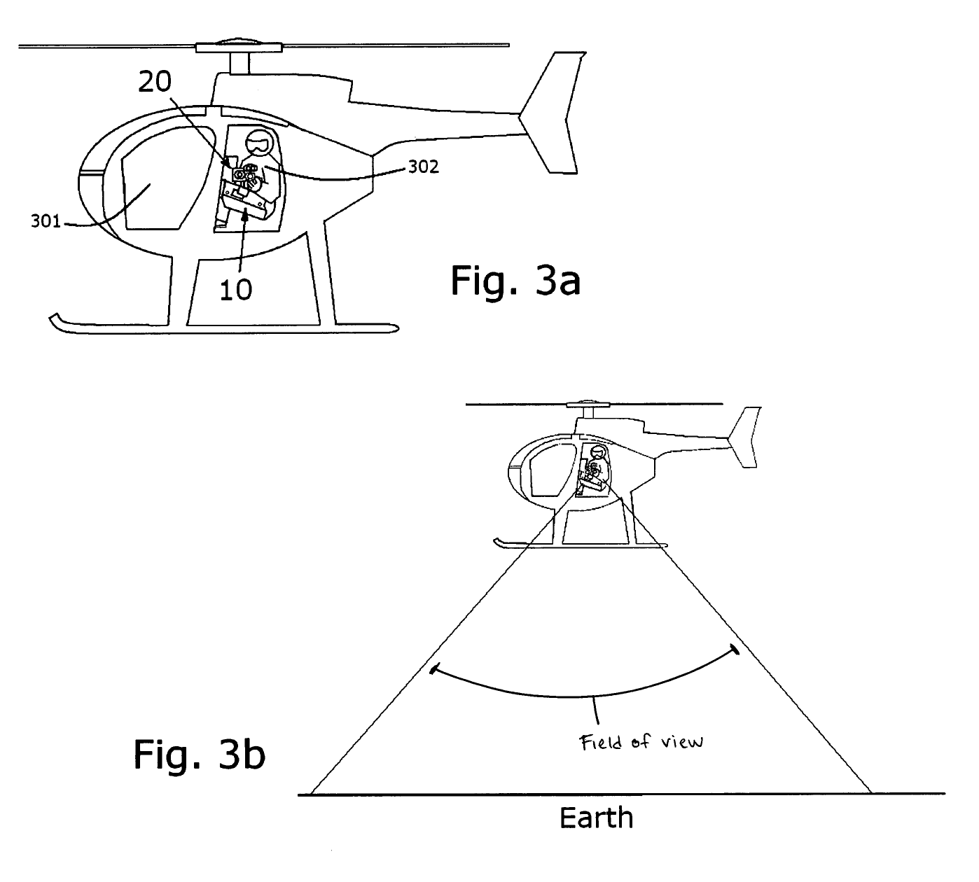

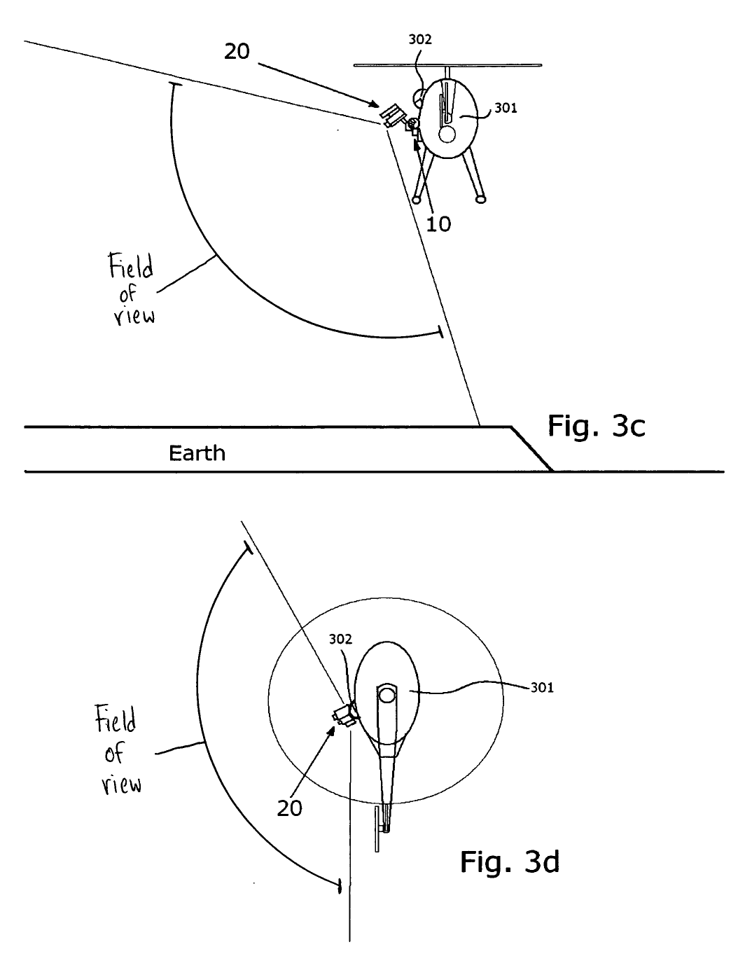

A typical embodiment of the complete MOBILE LASER DESIGNATED ARED MULTIMEDIA MAPPING SYSTEM is illustrated in FIG. 2B. The mobile are platform 10 without any computers, cameras, or sensors is illustrated in FIG. 1A to 1E. The typical embodiment of the mobile hardware platform consists of two pieces, the top piece 101 and the bottom piece 102, which together combine to form the complete mobile hardware platform 10 and camera mounting arm 103. Depending upon the size of the operator 302 the mobile hardware platform 10 can be adjusted using the adjustment holes 107 to move the top 101 and bottom 102 closer together or further apart depending upon the operator's dimensions. The camera-mounting arm 103 is attached to the three way tripod head 104. The three-way tripod head 104 enables the operator to move the camera and sensor array within a three-axis plane of motion, utilizing roll, pitch, and yaw FIGS. 3A to 3D. The camera and sensor mounting plate 105 can also be customized to facilitate almost any aerial data collection application. The preferred embodiment of the mobile hardware platform 10 is shown in FIGS. 1A through 1E, where the mounting plate 105 is set up for the camera and sensory configuration as seen in FIGS. 2A to 2B. The complete mobile hardware platform 10 will be referred to as a single component. FIG. 2A shows the typical computer, camera, and sensory configuration for the complete MOBILE LASER DESIGNATED INFRARED MULTIMEDIA MAPPING SYSTEM. This is the preferred configuration because of its versatility, although it is only one of many possible camera, sensory, and hardware configurations. Depending upon our client's needs we can incorporate different cameras and sensors including, but not limited to, multispectral cameras, different formats of imagery or film, frequency or wave detection devices, magnetic sensors, additional types of positioning sensors, or any other type of data collection equipment which can physically fit onto our camera and sensor mounting plate 105. The system configuration in the schematic FIG. 2A is shown completely installed onto the mobile hardware platform 10 in FIG. 2B. Although there are several different configurations of technological hardware available, our preferred embodiment includes a multi-spectral camera 200 and a visual camera 201. The MOBILE LASER DESIGNATED INFRARED MULTIMEDIA MAPPING SYSTEM also utilizes a differential-GPS antenna 204 and receiver 211 to log its position real-time during flight. Also, connected in conjunction with these cameras and GPS receiver 211 is a laser rangefinder 203, which communicates with the 202 magnetic fluxgate compass with integrated tilt and roll sensors, every time it is fired, to calculate ranged targets. All the data is sent to the mobile computer 205 for analysis, computations, post-processing, and data storage. To facilitate flow of information from the sensors 202, 203, and 204 to be received properly by the computer 205 they must be connected via data acquisition hardware 208, 210, and 211. The said data acquisition hardware interfaces the sensors directly with the mobile computer 205. These real-time data acquisition hardware components are shown in FIG. 2B to be enclosed in a protective box above the data recorder 207. Imagery can be recorded real-time through to data recorder 207 while viewed at the same time on the mobile computer's 205 screen. The data recorder 207 can be, but is not limited to, a recording to a magnetic tape recorder, compact disc recorder, digital video disc burner, a removable storage device, or a computer hard drive. Currently the data recorder 207 needs AC power to function so we had a power inverter 206 made which converts the aircrafts DC power into AC power. The adapter plug 209 can be adapted or changed to fit almost any type of existing aircraft's external power supply.

Operation—FIGS. 2B, 3A to 3D

The manner of using the MOBILE LASER DESIGNATED INFRARED MULTIMEDIA MAPPING SYSTEM is slightly different for every ramification. Our preferred embodiment as shown in FIG. 2B is the typical setup for the following applications including but not limited to, fire monitoring, utilities inspection, electrical inspection, machine inspection, forest vegetation management, agricultural inspection, commercial and residential building inspection, homeland security, wildlife and habitat aerial mapping, aerial surveillance, and marijuana garden identification and mapping. Once the MOBILE LASER DESIGNATED INFRARED MULTIMEDIA MAPPING SYSTEM is configured for the proper application, both the operator 302 and the MOBILE LASER DESIGNATED INFRARED MULTIMEDIA MAPPING SYSTEM would prepare to enter the aircraft. First the operator 302 sits in the helicopter 301 and then the MOBILE LASER DESIGNATED INFRARED MULTIMEDIA MAPPING SYSTEM is handed to the operator. The operator plugs in the power adapter 209 to the aircrafts external power supply. Once the aircraft is started the operator begins setting up the software for the mission specifics.

Once the aircraft and operator are airborne the mapping process beings and the operator continuously scans the earth below as represented in FIGS. 3B through 3D. FIG. 3A represents the typical operating environment of the MOBILE LASER DESIGNATED INFRARED MULTIMEDIA MAPPING SYSTEM and operator 302. Generally, the MOBILE LASER DESIGNATED INFRARED MULTIMEDIA MAPPING SYSTEM will be mounted with the operator inside the rotorcraft or light fixed wing aircraft to collect data outside the aircraft. The door will be removed for the operator 302 so the camera and sensor array 20 can sit just outside the aircraft to facilitate better field of view. The operator can scan the earth below in any of three directions. The three-way tripod head 104 enables the operator to move the camera and sensor array 20 to best suit his current seating position while acquiring ground based target's information. Once the roll variable is adjusted to where the operator's cameras are horizontal with the earth's horizon as seen in FIG. 3A the operator then manipulates the pitch and yaw of the camera and sensor array 20 to search for ground based targets. The restrictions of field of view are illustrated in FIGS. 3B through 3D. As the aircraft approaches the target location the operator 302 uses the GPS antenna 204 and GPS receiver 211 to continuously log the aircrafts movement real-time. As the aircraft travels, its geo-spatial position and direction of travel are recorded to data recorder 207 and the mobile computer 205 real-time. The said information is visibly monitored real-time by the operator on the mobile computer's 205 screen. The mobile computer screen 205 also displays the infrared video imagery from the infrared camera 200 in real-time. Real-time corresponding video imagery can be viewed on the same computer screen 205 at the exact same time for easier analysis and correlation.

Any time the operator identifies a target he can use the laser rangefinder 203 to acquire the said target's GPS positioning coordinates. When the laser rangefinder 203 is fired, the distance ranged, the magnetic heading from the magnetic compass 202, and the tilt sensors positions are recorded simultaneously. These variables are then automatically calculated by the computer 205 to determine the said targets exact geo-referenced location. At the same time the said GPS positioning coordinates are being recorded the MOBILE LASER DESIGNATED INFRARED MULTIMEDIA MAPPING SYSTEM also records correlating imagery. The multi-spectral camera 200 and the visual camera 201, which are triggered to fire simultaneously, record video or still photos of the said target at the same time position information is recorded. All this data is sent to the mobile computer 205 and data recorder 207 for storage and for post-processing. A perimeter can also be recorded by simply logging the MOBILE LASER DESIGNATED INFRARED MULTIMEDIA MAPPING SYSTEM's source GPS coordinates sequentially as the aircraft moves around the desired perimeter. These GPS locations collected will later be used during post-processing to create geometric polygons to represent perimeters and to calculate volumes encompassed and distances of areas within perimeters inspected. Once data collection is complete the aircraft and MOBILE LASER DESIGNATED INFRARED MULTIMEDIA MAPPING SYSTEM land back at the point of origin. The operator then exists the aircraft with the MOBILE LASER DESIGNATED INFRARED MULTIMEDIA MAPPING SYSTEM and heads to a location where he can analyze and process the data collected. The output is tailored for each individual client. Formats of output include, but are not limited to, physically printed on paper or onto topographical maps, burned to CD, burned to DVD, recorded to a removable storage device, copied to magnetic tape, or emailed as digital information. Depending upon the application, information can also be sent directly from the MOBILE LASER DESIGNATED INFRARED MULTIMEDIA MAPPING SYSTEM while it is still airborne via cellular modem, satellite modem, microwave signals, or other forms of wireless data transmission.

### SUMMARY OF THE INVENTION

Although the above description contains many specifications, these should not be construed as the limited the scope of the invention but as merely providing illustrations of some of the presently preferred embodiments and ramifications of this invention. For example, the infrared thromographic camera could be replaced with a multi-spectral camera for agricultural applications, forest vegetation analysis and management, burn area rehabilitation assessment, or commercial agricultural inspection. Some applications, which require greater GPS accuracy than our present differential GPS sensors provide might utilize a ground-based WAS station to correlate GPS time signals, received from satellites in orbit to ensure greater accuracies. The GPS mapping function can be used calculate perimeter distance and acreage with the said perimeter. The GPS mapping function can also calculate the distance traveled while in flight or for applications similar to mapping high-tension power lines.

There are also several different designs of the mobile hardware platform 10. While the preferred embodiment is currently aluminum construction, there are several other designs of the same hardware platform that utilize different materials of construction. Other modifications, including an integrated GPS antenna built into the top of the platform, more lightweight composite materials of construction, and camera and sensor enclosures have been planned for future designs and revisions. In future designs we have also eliminated the need for the power supply 206 and plug adapter 209 since we can simply purchase a battery operated data recorder. This system can easily be converted to operate completely independent of the aircraft by using batteries. There is also a good chance we will eliminate the need for an external data recorder altogether since we could simply use a mobile computer's hard drive providing it had sufficient memory space on the hard drive or anther external data recording device. Thus the scope of this invention should be determined by the appended claims and their legal equivalents, rather than by the examples given.

What is claimed as new and desired to be secured by Patent letters of the United States is:

1. A mobile remote sensing system for aerial based data acquisition comprising:
a mobile hardware platform
a multi-directional tripod head
a mounting plate to host various configurations of cameras and sensors
a multi-spectral camera
a visible imaging camera
a storage device for recording imagery
a geo-spatial data acquisition apparatus
a laser rangefinder
a magnetic compass with tilt and roll sensors
a mobile computer

2. The mobile hardware platform of claim 1 wherein said mobile hardware platform is connected to a means of controlling a multi-directional camera and sensor mount.

3. The multi-directional camera and sensor mount of claim 2 wherein said multi-directional camera and sensor mount is comprised of a multi-directional tripod head connected to a mounting plate for cameras and sensors which provide a physical means of mounting various configurations of cameras and sensors to the multi-directional tripod head whereby an operator can move the cameras and sensors simultaneously to observe and record features anywhere within the multi-directional camera and sensor mount's field of view.

4. The multi-directional camera and sensor mount of claim 3 wherein said means of multi-directional camera and sensor control is designed to serve as a foundation for several different camera and sensory configurations, mounted directly to the mounting plate, to facilitate recording different types of data outside the aircraft.

5. The multi-spectral camera of claim 1 mountable on said multi-directional camera and sensor mount to facilitate motion in any direction within the said mounts field of view while searching or recording targets external to the aircraft.

6. The visual camera of claim 1 mountable on said multi-directional camera and sensor mount to facilitate motion in any direction within the said mounts field of view while searching or recording targets external to the aircraft.

7. The a geo-spatial data acquisition apparatus of claim 1 mountable on said multi-directional camera and sensor mount including a means of outputting and receiving a positional data stream to the mobile computer, whereby said multi-spectral camera, visual camera, and geo-spatial data acquisition apparatuses being functional simultaneously to acquire time-related imagery and positional related data.

8. A completely mobile remote sensing system for aerial based data acquisition to be mounted from inside an aircraft with nothing fixed to the airframe of the aircraft.

9. A completely mobile remote sensing system for aerial based data acquisition with the means to acquire any remote targets geo-spatial position ranged from a distance from the aircraft and to acquire the said targets geo-spatial position real-time and in correlation with corresponding imagery collected from the cameras simultaneously in real-time.

10. The means to acquire a remote targets geo-spatial position from a distance from the aircraft of claim 9 wherein said means includes, but is not limited, to a laser rangefinder interfaced with a magnetic compass with integrated tilt and roll sensors, whereby an operator can select a target from a distance, trigger the laser range finder, whereas this data is recorded real-time while the mobile computers data processor simultaneously records the data acquired from the rangefinder, tilt and roll sensors, and geo-spatial data acquisition apparatus simultaneously which is processed in the mobile computer to determine the said targets exact geo-spatial positioning coordinates in real-time.

11. The said laser-designated targets geo-spatial positioning coordinates of claim 10 wherein said geo-spatial positioning coordinates can be acquired simultaneously in correlation with multi-spectral imagery and visual imagery to output multi-dimensional information packages for each individual target acquired via the laser rangefinder.
